(19) United States
(12) Patent Application Publication
(10) Pub. No.: US 2012/0017279 A1
(43) Pub. Date: Jan. 19, 2012

(54) METHOD AND APPARATUS FOR VIRUS THROTTLING WITH RATE LIMITING

(76) Inventor: Shaun Kazuo Wakumoto, Roseville, CA (US)

(21) Appl. No.: 13/260,170

(22) PCT Filed: Oct. 28, 2009
(86) PCT No.: PCT/US09/62408

§ 371 Date: Sep. 23, 2011

(51) Int. Cl. G06F 21/00; G06F 11/30

(52) U.S. Cl. 726/24

(57) ABSTRACT

A method for traffic control of a network device in a network are disclosed. The network device determines potentially malicious behavior by a host device in the network. A permissible rate of traffic from the host device through a port of the network device is reduced in response to determining the potentially malicious behavior. A rate of traffic through the port of the network device is measured. The measured traffic rate is compared with a threshold rate. The permissible rate of traffic is adjusted based on the comparison.

### I. BACKGROUND

Malicious forms of computer code include computer viruses. A computer virus is typically able to copy itself and infect a host computer. The virus may be spread from host computer to host computer by way of a network or other means. Antivirus software typically runs on a computer host so as to attempt to protect the computer host from becoming infected. Antivirus software typically uses signature-based techniques.

Virus throttling or connection-rate filtering is a technique for containing the damage caused by fast-spreading worms and viruses. Rather than attempting to prevent a computer host from becoming infected, virus throttling detects an infection in the host and takes action to inhibit the spread of the worm or virus from an infected machine. This reduces damage because the worm or virus is able to spread less quickly.

Virus throttling is based on controlling an infected machine's network behavior, and so does not rely on details of the specific virus. In other words, a virus signature is not needed to implement virus throttling. Although virus throttling does not prevent infection in the first place, it helps to contain damage by taking actions to restrict the spread of the virus. With such throttling, a virus or worm outbreak will grow less rapidly. Further, by damping down the spread of the virus or worm, the throttling buys time for signature-based solutions to reach machines before the virus or worm. New viruses that do not have a signature may be used to launch “zero day attacks.” Virus throttling uses connection characteristics which allows for the detection of these zero day attacks.

Virus throttling technology has been implemented, for example, in the ProCurve® Switch 5400xl available from the Hewlett-Packard Company. Virus throttling typically works by detecting an infected host by monitoring connection requests at the networking layer 3 or layer 2 levels. When a given host satisfies a certain number of unique connection requests within a specific amount of time, the networking device may consider this host to be infected by malicious code (such as a virus or worm) and may take appropriate actions.

### II. BRIEF DESCRIPTION OF THE DRAWINGS

The present disclosure may be better understood and its numerous features and advantages made apparent to those skilled in the art by referencing the accompanying drawings.

FIG. 1 is a block diagram of a network in accordance with an embodiment of the invention.

FIG. 2 is a simplified flow diagram depicting a method of virus throttling in accordance with an embodiment of the invention.

FIG. 3 is another simplified flow diagram depicting a method of virus throttling in accordance with an embodiment of the invention.

FIG. 4 is a block diagram of an exemplary switching or routing device in accordance with an embodiment of the invention.

### III. DETAILED DESCRIPTION

Virus throttling is useful to detect and deal with cases where a host device (source) is infected with a virus and is trying to spread itself. After detecting that a host device is infected, various remediation actions may be performed to minimize the impact of the virus to other components in a network. Typically, these actions include engaging a blocking scheme by blocking suspect traffic from potentially high-risk locations until a network administrator manually unblocks the traffic, engaging a timed-block scheme by blocking the suspect traffic for a limited amount of time, or engaging a notification scheme by sending a notification message, for example to the network administrator, in response to detecting an infected host.

These and other remediation actions address one negative aspect of viruses, i.e., limiting the spread of the worm or virus to other network nodes. A method for virus throttling is described herein that addresses another negative aspect of viruses, i.e., the creation of increased traffic which can lead to a shortage of bandwidth for legitimate traffic. For example, viruses may send out many copies of themselves, and other types of malicious software (or “malware”) may send unsolicited advertising to multiple recipients or may saturate a target network node with communication requests, such as in a denial of service (DOS) attack.

Instead of timed blocking or blocking traffic altogether, rate limiting (after detection of an infected host) allows the infected host to utilize a reduced amount of bandwidth. Thus, the amount of bandwidth that the infected host is allowed to consume is reduced, but not eliminated.

A method for traffic control of a network device in a network is disclosed. The network device determines potentially malicious behavior by a host device in the network. A permissible rate of traffic from the host device through a port of the network device is reduced in response to determining the potentially malicious behavior. A rate of traffic through the port of the network device is measured. The measured traffic rate is compared with a threshold rate. The permissible rate of traffic is adjusted based on the comparison.

In another embodiment, an edge network device is configured with virus-throttling with rate-limiting. The device includes an edge port and a remediation engine which is communicatively coupled to the edge port. The remediation engine may determine potentially malicious behavior by a host device in a network, reduce a permissible rate of traffic from the host device through the edge port in response to determining the potentially malicious behavior, measure a rate of traffic through the edge port, compare the measured traffic rate with a threshold rate, and adjust the permissible rate of traffic based on the comparison.

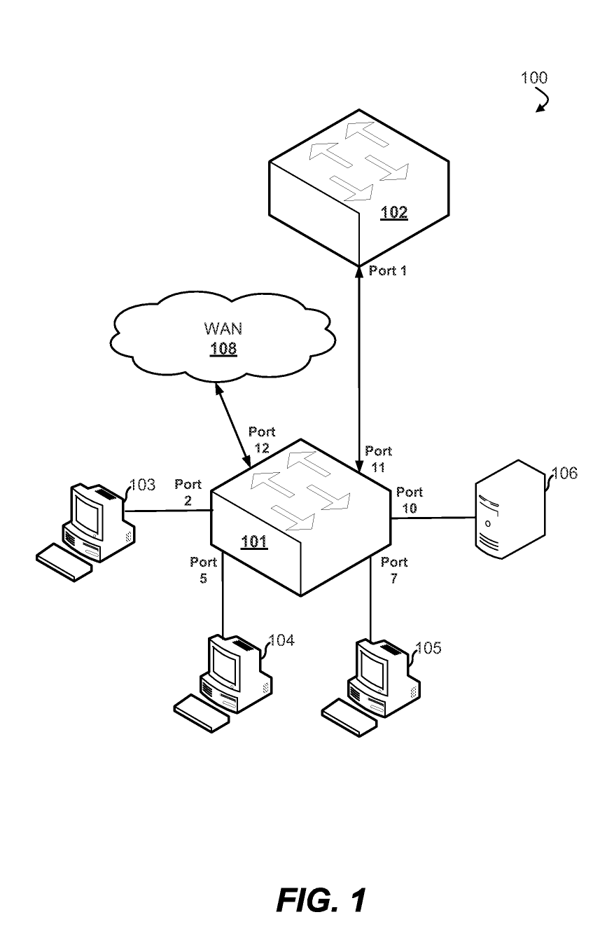

FIG. 1 is a block diagram of a network 100 in accordance with an embodiment of the invention. Network 100 includes switch 101, switch 102, host device 103, host device 104, host device 105, server 106, and wide area network (WAN) 108.

Switch 101 is operatively coupled to host devices 103-105, server 106, switch 102, and WAN 108. Switch 101 is configured to forward, analyze, and/or filter packets, and may be further configured to perform virus throttling with rate limiting. Switch 101 is an edge network device. As used herein, an edge network device is a switch, router, or other network device that is connected to a host device via an edge port or connected to an external network via the edge port. As used herein, an edge port is a port in an edge network device which is directly connected to a host device or external network.

Switch 102 is operatively coupled to switch 101 via port 11 of switch 101. The connection between switch 101 and switch 102 may include multiple network segments, transmission technologies and components. Switch 102 is configured to forward, analyze, and/or filter packets, and may be further configured to perform virus throttling with rate limiting.

A host device interfaces with a network device in the network. A host device may include a personal computer, a server, a handheld computing device, etc. Host devices 103-105 are all operatively coupled to switch 101. Host device 103 is operatively coupled to edge port 2 of switch 101. Host device 104 is operatively coupled to edge port 5 of switch 101. Host device 105 is operatively coupled to edge port 7 of switch 101. Server 106 is also operatively coupled to switch 101. In particular, server 106 is operatively coupled to edge port 10 of switch 101.

In accordance with an embodiment, a switch may monitor connections initiated by the host which may include internet protocol (IP) flows arriving in the enabled port(s). The remediation engine may determine a host device (i.e., source address) is an infected host. Virus throttling with rate limiting may be enabled on a per-client, per-port, and ingress basis. When enabled on one or more of the ports (i.e., edge ports or non-edge ports) of a switch, such as switch 101 and switch 102, the remediation engine may apply a rate limit on a per-client basis to provide a greater level of granularity as opposed to rate-limiting all traffic at the enabled port regardless of the source. In particular, a permissible rate of traffic allowed may be reduced or otherwise limited. As used herein, the permissible rate of traffic is the maximum bandwidth utilization rate that is allowed.

For example, virus throttling with rate-limiting may be enabled for ingress traffic at port 5 of switch 101. Upon detecting that host device 104 is an infected host, all ingress traffic from the infected host at port 5 is restricted to a permissible rate of traffic (i.e., maximum bandwidth utilization rate). The rate may be a configurable fraction of the total allocated bandwidth, a bandwidth value, etc. Thus, if a rate of 1 Gbps is allocated, the permissible rate for ingress traffic at port 5 may be reduced to 2% utilization, or 20 Mbps.

In one embodiment, the methods as described herein are performed by non-edge network devices. Virus throttling with rate-limiting may be performed provided the identity of the infected host device (i.e., source address) is known or can be ascertained. For example, virus throttling with rate-limiting is enabled for ingress traffic at port 1 of switch 102. Upon detecting that host device 104 is an infected host, all ingress traffic from the infected host at port 1 is restricted to the permissible rate of traffic.

FIG, 2 is a simplified flow diagram depicting a method of virus throttling in accordance with an embodiment of the invention. The depicted process flow 200 is carried out by execution of one or more sequences of executable instructions. In another embodiment, the process flow 200 is carried out by execution of components of a network device, an arrangement of hardware logic, e.g., an Application-Specific Integrated Circuit (ASIC), etc. Virus throttling with rate limiting may be performed by a remediation engine, for example at a network device, a central network management server, other node in the network, or any combination thereof.

At step 210, potentially malicious behavior by a host device (i.e., infected host) is determined. In one embodiment, a network device may monitor and detect for hosts which exhibit virus-like behavior, such as behavior indicative of a fast-spreading virus or worm. The remediation engine may be made aware of the infected host or may otherwise determine the infected host.

Upon determination of the infected host, at step 220, a rate limit may be applied to traffic of the infected host. In particular, a permissible rate of traffic from the host device through a port of the network device is reduced. As previously described, the permissible rate of traffic is the maximum bandwidth utilization rate that is allowed. A rate limit may be applied on a per-client and per-port basis at all ports of the network node for which virus throttling is enabled. For example, all traffic from a source address of the infected client may be rate limited by a configurable amount.

In one embodiment, rate limiting may be applied to specific types of traffic, e.g., protocol and/or protocol port number. A network interface of a network device may support many protocols, such as Internet protocol (IP), Internet control message protocol (ICMP), transmission control protocol (TCP), user datagram protocol (UDP), simple network management protocol (SNMP), file transfer protocol (FTP), hypertext transfer protocol (HTTP), and others. Viruses may be known to favor certain protocols and/or protocol ports. Some viruses may use a particular User Datagram Protocol (UDP) port for launching attacks. Virus throttling with rate-limiting may be performed on a per-client, per-port, and per-traffic basis such that traffic from the infected client may be rate-limited at the particular UDP port, Other methods for distinguishing among types of traffic may be implemented.

### Adjustments to Rate-Limited Utilization

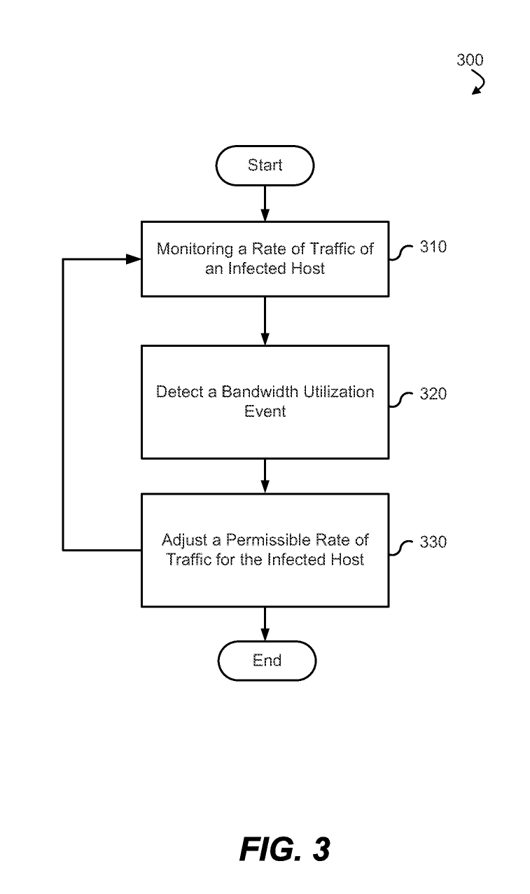

FIG. 3 is another simplified flow diagram depicting a method of virus throttling in accordance with an embodiment of the invention. The depicted process flow 300 is carried out by execution of one or more sequences of executable instructions. In another embodiment, the process flow 300 is carried out by execution of components of a network device, an arrangement of hardware logic, e.g., an Application-Specific Integrated Circuit (ASIC), etc. Virus throttling with rate limiting may be performed by a remediation engine, for example at a network device in a network.

Even after virus throttling with rate limiting has been applied on an infected host, it may be desirable to adjust the rate limits in light of bandwidth utilization events that may have occurred. Process flow 300 may be performed, for example after a rate limit has been applied on an infected host.

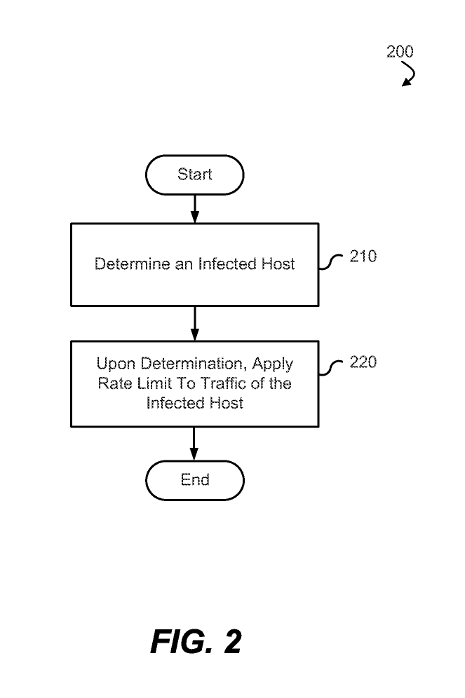

At step 310, a rate of traffic of an infected host is monitored. The infected host has been previously rate-limited, for example as described in FIG. 2. A rate of the infected host's traffic (i.e., bandwidth utilization rate) through a port of the network device is measured.

At step 320, a bandwidth utilization event is detected. In one embodiment, these events may include detection that a bandwidth utilization threshold has been satisfied, which may be used to determine whether a further decrease or an increase in the permissible rate of traffic of the infected host is warranted. The events may be pre-configured, for example by a network administrator, or may be set as a default configuration by a network management server. The rate of traffic measured at step 310 may be compared with one or more configurable threshold rates to determine whether any adjustments are warranted.

A high threshold rate may be used to indicate “bad” behavior by a virus, Le., the virus is consuming all or nearly all of the permissible traffic rate which was previously reduced. For example, if the permissible traffic rate (which has been previously reduced) is at 2% maximum utilization, the high threshold may be set for a window of 1.75%-2%. A bandwidth utilization event may be detected where the rate of traffic measured at step 310 falls within the high threshold window.

A low threshold rate may be used to indicate “good” behavior by a virus, i.e., the virus is not consuming much of the permissible rate of traffic. For example, if the permissible traffic rate (which has been previously reduced) is at 1% maximum utilization, the low threshold may be set for a window of 0.5%-1%. A bandwidth utilization event may be detected where the rate of traffic measured at step 310 falls within the low threshold window.

Moreover, the low threshold rate or a virus removal threshold rate may be used to detect the removal of the virus. A large reduction in user traffic may indicate the removal of the virus from the host. As such, the virus removal threshold rate may be set to detect for a rate indicative of virus removal or detect a normal rate of bandwidth utilization, i.e., by a non-infected host or a previously infected host who is no longer infected. A bandwidth utilization event may be detected where the rate of traffic measured at step 310 satisfies the virus removal threshold.

At step 330, a permissible rate of traffic of the infected host is adjusted. The permissible rate of traffic from the host device through the port of the network device may be adjusted based on the comparison to the one or more threshold rates. The amount of the adjustment may be configurable and/or determined by a policy associated with the detected event.

Where the high threshold rate is satisfied, the permissible rate of traffic may be decreased by a configurable amount. For example, a permissible traffic rate may be decreased from 2% maximum utilization to 1% maximum utilization. Where the low threshold rate is satisfied, the permissible rate of traffic may be increased by a configurable amount. For example, a permissible traffic rate may be increased from 1% maximum utilization up to 1.5% maximum utilization. Processing may loop back to step 310, where further monitoring is performed, until it is determined that no further adjustment will be considered. Where the virus removal threshold rate is satisfied, the permissible rate of traffic may be increased by a configurable amount.

Viruses may be bursty in nature or otherwise likely to send data at many times over a normal rate for short periods of time. Bursty traffic may cause repeated toggling of increased and decreased permissible traffic rates. A counter may be used to track a number of adjustments to the permissible rate of traffic. For example, the counter tracks each point of inflection at which the permissible traffic rate changes by an increased amount then a decreased amount and/or a decreased amount then an increased amount. A toggle threshold may identify a maximum number of adjustments allowed to the traffic rate. The number of adjustments tracked by the counter may be compared with the toggle threshold. In one embodiment, the toggle threshold may represent a behavioral symptom of a bursty virus. In one embodiment, traffic may be blocked or time-blocked, or a notification may be sent if the toggle threshold has been satisfied. The traffic may remain blocked until a command is received to unblock traffic from the host device.

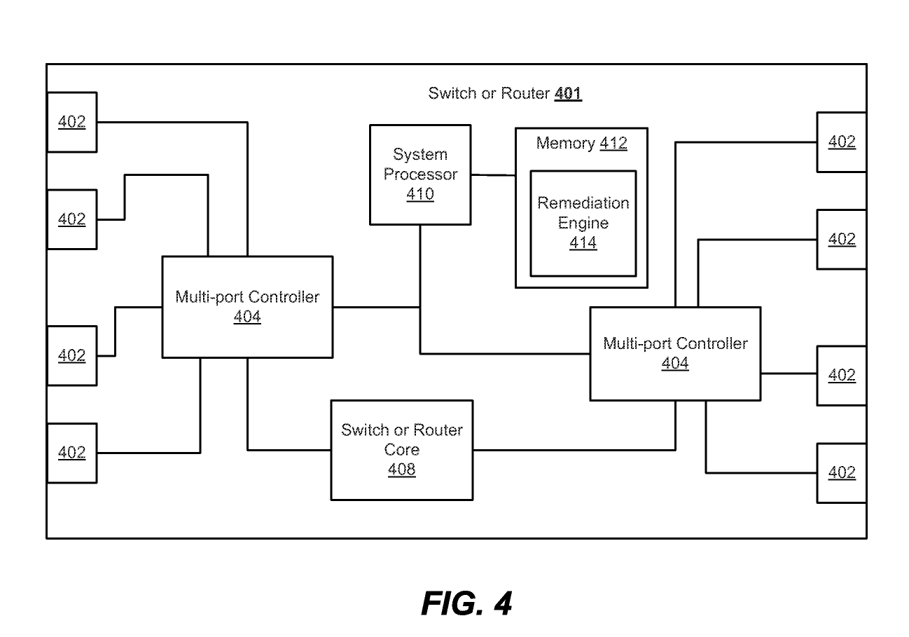

FIG. 4 is a block diagram of an exemplary switching or routing device in accordance with an embodiment of the invention. Switching or routing device 401 may be configured with multiple ports 402. The ports 402 may be controlled by one or more controller ASICs (application specific integrated circuits) 404.

The device 401 may transfer (i.e. “switch” or “route”) packets between ports by way of a conventional switch or router core 408 which interconnects the ports. A system processor 410 and memory 412 may be used to control device 401. For example, a remediation engine 414 may be implemented as code in memory 412 which is being executed by the system processor 410 of device 401.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage medium that are suitable for storing a program or programs that, when executed, for example by a processor, implement embodiments of the present invention. Accordingly, embodiments provide a program comprising code for implementing a system or method as claimed in any preceding claim and a machine readable storage medium storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method for traffic control of a network device in a network, the method comprising:
determining, by the network device, potentially malicious behavior by a host device in the network;
reducing a permissible rate of traffic from the host device through a port of the network device in response to determining the potentially malicious behavior;
measuring a rate of traffic through the port of the network device;
comparing the measured traffic rate with a threshold rate; and
adjusting the permissible rate of traffic based on the comparison.

2. The method of claim 1, wherein the network device is an edge switch and wherein the port is an edge port of the network device.

3. The method of claim 1, further comprising:
tracking a number of adjustments to the reduced rate of traffic; and
comparing the number of adjustments to a toggle threshold, the toggle threshold identifying a maximum number of adjustments allowed.

4. The method of claim 3, further comprising blocking traffic from the host device if the number of adjustments satisfies the toggle threshold.

5. The method of claim 4, wherein the traffic is blocked until a command is received to unblock traffic from the host device.

6. The method of claim 1, wherein adjusting the reduced rate of traffic comprises decreasing the permissible rate of traffic by a configurable amount if the measured traffic rate satisfies the threshold rate.

7. The method of claim 1, wherein adjusting the reduced rate of traffic comprises increasing the permissible rate of traffic by a configurable amount if the measured traffic rate satisfies the threshold rate.

8. The method of claim 1, further comprising detecting a pre-configured event in response to measuring the rate of traffic.

9. An edge network device configured with virus-throttling with rate-limiting, the device comprising:
an edge port;
a remediation engine communicatively coupled to the edge port, wherein the remediation engine is configured to:
determine potentially malicious behavior by a host device in a network;
reduce a permissible rate of traffic from the host device through the edge port in response to determining the potentially malicious behavior;
measure a rate of traffic through the edge port;
compare the measured traffic rate with a threshold rate; and
adjust the permissible rate of traffic based on the comparison.

10. The edge network device of claim 9, wherein the remediation engine is configured to:
track a number of adjustments to the reduced rate of traffic; and
compare the number of adjustments to a toggle threshold, the toggle threshold identifying a maximum number of adjustments allowed.

11. The edge network device of claim 9, wherein the remediation engine is configured to block traffic from the host device if the number of adjustments satisfies the toggle threshold.

12. The edge network device of claim 9, wherein the traffic is blocked until a command is received to unblock traffic from the host device

13. The edge network device of claim 9, wherein the remediation engine is configured to adjust the permissible rate of traffic by decreasing the reduced rate of traffic by a configurable amount if the measured traffic rate satisfies the threshold rate.

14. The edge network device of claim 9, wherein the remediation engine is configured to adjust the permissible rate of traffic by increasing the reduced rate of traffic by a configurable amount if the measured traffic rate satisfies the threshold rate.

15. The edge network device of claim 9, wherein the remediation engine is configured to detect a pre-configured event in response to measuring the rate of traffic.
